(19) United States
(12) Patent Application Publication
(10) Pub. No.: US 2004/0191441 A1
(43) Pub. Date: Sep. 30, 2004

(54) Laminated polymer composite material

(76) Inventors: Martin Bureau, Montreal (CA); Johanne Denault, Longueull (CA); Gilbert Lebrun, Ste-Julie (CA)

Correspondence Address: NATIONAL RESEARCH COUNCIL OF CANADA, 1500 MONTREAL ROAD, BLDG M-58, ROOM EG12, OTTAWA, ONTARIO, K1A 0R6, CA

(21) Appl. No.: 10/765,172

(22) Filed: Jan. 28, 2004

Related U.S. Application Data
(60) Provisional application No. 60/443,552, filed on Jan. 30, 2003.

(51) Int. Cl. F16L 1/00

(52) U.S. Cl. 428/34.6; 428/35.7; 428/292.1; 428/500

(57) ABSTRACT

The invention disclosed relates to laminated polymer composite material comprising, a base structural member having at least one major surface and an overlay layer of polymer linked, e.g by fusion bonding, to at least a portion of said at least one major surface of the structural member, wherein the polymer is any polymer which can be thermally activated to obtain chemical and/or physical links with the structural member, and to a process and apparatus for making same.

### CROSS-REFERENCE TO RELATED APPLICATION

The application claims priority from U.S. Provisional Application Serial No. 60/443,552, filed 30 Jan. 2003.

### FIELD OF INVENTION

This invention relates to laminated polymer composite materials, and more particularly to a laminated polymer composite material having mechanical properties comparable to hardwood products. This invention also relates to a method and apparatus to produce laminated such materials from strips or sheets of material.

### BACKGROUND OF THE INVENTION

Environmental legislation and public awareness regarding wood-cutting exploitation combined with recent advances in materials science, put pressure on the manufacturers to progressively replace hardwood as a material in all types of applications, by synthetic or recycled wood materials. Wood-filled thermoplastic polymers have been introduced in a number of semi-structural and aesthetic applications in industrial, automotive and construction applications, such as railings, decking, flooring, panels, and moldings of all sorts. These industries are currently either considering or using these polymers for structural applications. One particular application considered is the replacement of high performance laminated wood flooring currently used for material handling and transport trailer flooring. Although they are efficient against environmental stresses (moisture, fungus, insects, spilled products, etc.), wood-filled polymers have superior specific weight and inferior mechanical properties in comparison to hardwood products. The known high-density wood-filled polymers have a specific weight and mechanical properties ranging between those of non-reinforced thermoplastic polymers and those of softwood.

The products presently used for material handling and transport trailer flooring are made of maple or oak wood strips, which are adhesively bonded to each other, longitudinally and laterally, into a sheet or plate of given length, width and thickness. The joints between the strips are in some cases reinforced by tongues and grooves of different configuration, such as Z-shaped or L-shaped. However, these sheets present a number of disadvantages or problems. One of the problems relates to their jointed structure, where the mechanical properties in the lateral direction are considerably lower compared to the corresponding mechanical properties in the longitudinal direction. A second problem with the existing hardwood systems is that they are subjected to degradation in conjunction with abrasion and wear, especially at the bonded joints of the strips, caused by environmental conditions, namely moisture, fungus and even insects. Environmental legislations and predictable future price increases for conventional wood products is another major issue with the existing hardwood systems. All these factors provide incentives for alternative synthetic and/or recycled products.

As a solution, it has been proposed to replace hardwood in a high performance/low weight application similar to existing wood flooring systems, with extruded or pultruded polymer profiles or structural members. Patent documents FR 2 724 342, WO 99/56936, WO 01/21367 A1, U.S. Pat. No. 4,851,458, U.S. Pat. No. 5,406,708, U.S. Pat. No. 5,497,594, U.S. Pat. No. 5,518,677, U.S. Pat. No. 5,539,027, U.S. Pat. No. 5,486,553, U.S. Pat. No. 5,827,607, U.S. Pat. No. 5,441,801 are some examples of this proposed solution. These profiles or structural members comprise a cellulosic fiber-thermoplastic (namely PVCX) polymer composite, onto which a fiber-reinforced thermosetting polymer composite is adhesively bonded to improve its mechanical properties, such as strength and rigidity. An example of this solution is disclosed in U.S. Pat. No. 6,007,656. A variation of this solution is proposed in the International published patent application WO 00/78541 A1, where a core of wood-fiber thermoplastic composite is first consolidated, and then chemically modified at its surface by grafting, for adhesion with an upper and/or lower face layer also composed of a wood-fiber thermoplastic composite.

Other solutions to improve existing hardwood system have been proposed. However, to date, they have been focused on modifications or additions to the existing solid wood system, not replacement of the latter.

Another proposal [U.S. Pat. No. 5,928,735] consists in adhesively bonding fiber-reinforced thermosetting polymer composites on the bottom face of the laminated wood flooring. This improvement is claimed to lead to better short-term and long-term performance, which include improved stiffness and strength, impact resistance, heat deflection temperature, creep resistance, environmental resistance (moisture, fungus, insects, spilled products, contaminants or objects thrown by the wheels), fatigue resistance, and wear and abrasion resistance.

Another prior art proposal is the reinforcement of a hard wood construction by adding layers containing a thermoplastic polymer, namely PP, reinforced by a series of fibers or fillers, namely wood or cellulose fibers [FR 2 690 221]. Modifications based of the latter two patents have also been reported [U.S. Pat. No. 4,801,483, U.S. Pat. No. 6,179,942, U.S. Pat. No. 5,139,845, U.S. Pat. No. 4,210,692, U.S. Pat. No. 6,183,824, U.S. Pat. No. 6,318,794, US 2001/0003623, CA 2,306,308, U.S. Pat. No. 5,928,735]. However, simply reinforcing laminated wood flooring by using a fiber-reinforced composite does not take advantage of the low cost wood-polymer composite recently developed, nor does it address the question of recycled product content due to the use of hard wood. Moreover, using fiber-reinforced thermosetting polymer composites does not address also the fundamental environment protection requirements, such as possible VOC emissions during the lamination of the fiber-reinforced thermosetting polymer composite, and end-of-life recyclability of the product due to its thermosetting polymer content. Shelf life problem is also an issue with thermosetting polymers.

Other structural members have been proposed. See U.S. Pat. No. 5,439,749 and U.S. Pat. No. 6,344,267. However, structural members, whether strictly composed of thermoplastic polymers or of wood-polymer composites, do not present the specific weight and mechanical properties that match those of high performance laminated wood flooring. Improving performance by profiling structural members with complex interior structures (C-channel, I-beam, V-channel, etc.), although significant, cannot match the mechanical properties of high performance laminated wood flooring (longitudinal flexural modulus and strength of the solid laminated wood flooring are respectively of the order of 8-10 GPa and 90-120 MPa). Laminating an exterior layer of fiber-reinforced thermosetting polymer composite on the bottom and/or the upper surface of a thermoplastic polymer-based core to improve its properties requires good adhesion between the thermoplastic polymer used for the core and the thermosetting polymer composites used for the upper and bottom layers, which limits the number of thermoplastic and thermosetting polymers that can be used. Namely, thermoplastic polyolefin polymers, such as polypropylene (PP) and polyethylene (PE) commonly used based on performance/cost/process considerations, are known for their chemical inertness, which makes good adhesion of the latter to any thermosetting polymer composite difficult to obtain. Using fiber-reinforced thermosetting polymer composites as reinforcing layers also complicates recyclability of the resulting structural member and, depending on the thermosetting polymer used, can lead to volatile organic compounds (VOCs) that need to be treated during the manufacturing process, not to mention shelf life issues.

There is a need for a low cost synthetic product with specific weight and mechanical properties similar to the high performance laminated wood flooring.

### SUMMARY OF THE INVENTION

The present invention addresses the foregoing problems of the prior art.

According to one aspect of the invention, a laminated polymer composite material is provided comprising, a base structural member having at least one major surface and an overlay layer of polymer linked to at least a portion of said at least one major surface of the structural member, wherein the polymer is any polymer which can be thermally activated to obtain chemical and/or physical links with the structural member.

In a further aspect of the invention, there is provided a process to produce such a laminated polymer composite material, comprising the steps of, heating at least a portion of at least one major surface of a base structural member, bringing an overlay layer of polymer material into contact with the heated surface, and applying pressure to link the structural member to the layer of polymer material.

In yet another aspect of the invention, there is provided an apparatus to produce such a laminated polymer composite material comprising, heating means for heating at least a portion of at least one major surface of a base structural member, means for bringing a layer of polymer into contact with said at least one major surface of the structural member, and press means for applying pressure to link the structural member to the layer of polymer material.

Having thus generally described the invention, reference will now be made to the accompanying drawings.

### BRIEF DESCRIPTION OF THE DRAWINGS

FIG. 1 is a section view of a laminated polymer composite material, having an upper polymer layer.

FIG. 2 is a section view of a laminated polymer composite material, having a lower polymer layer.

FIG. 3 is a section view of a laminated polymer composite material, having lower and upper polymer layers.

FIG. 4 is a section view of the laminated polymer composite material of FIG. 3, having a series of square-channel hollow profiles.

FIG. 5 is a section view of the laminated polymer composite material of FIG. 3, having a series of triangular-channel hollow profiles.

FIG. 6 is a section view of the laminated polymer composite material of FIG. 3, having a series of circular-channel hollow profiles.

FIG. 7 is a section view of the laminated polymer composite material of FIG. 3, having a series of L-shaped profiles.

FIG. 8 is a schematic view of the laminated polymer composite material of FIG. 3 showing the profile geometry of the structural member.

FIG. 9 is a schematic view of an apparatus to produce, as a continuous process, a laminated polymer composite material from strips of material.

FIG. 10 is a schematic view of an apparatus to produce, as a batch process, a laminated polymer composite material from sheets of material.

### DETAILED DESCRIPTION OF THE INVENTION

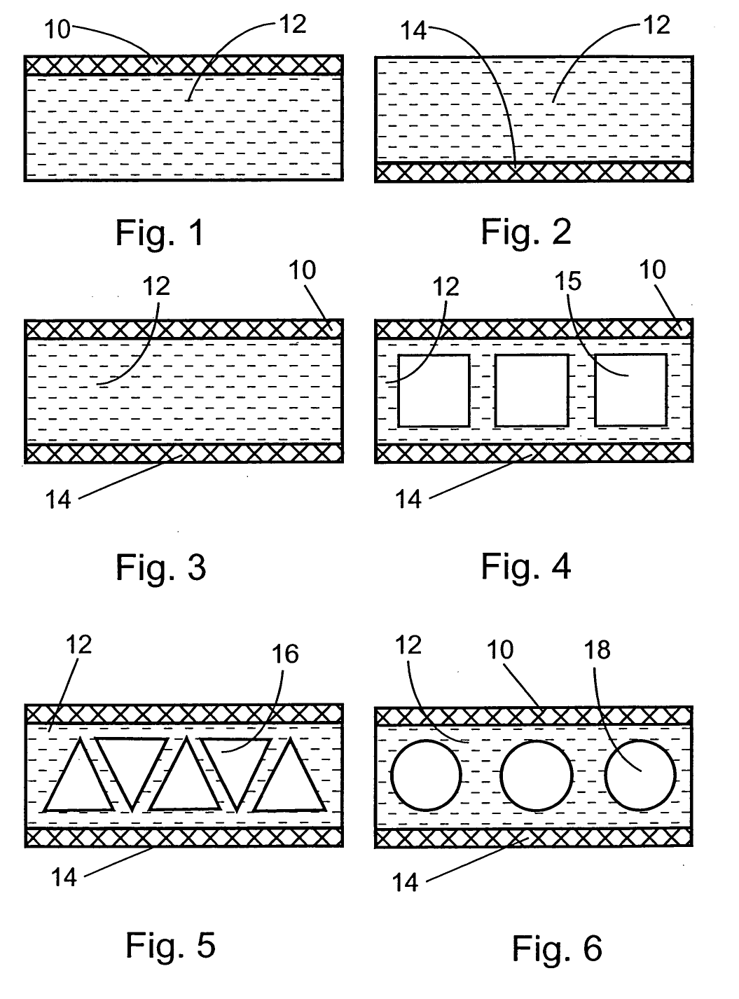

Referring to FIGS. 1, 2 and 3, the present invention provides, generally, a layered product comprising an upper 10 and/or a lower overlay layer 14 of polymer, and a base structural member 12. The layers of polymer (10 and 14), comprise any polymer which can be thermally activated to obtain chemical and/or physical links with the structural member 12. Such links may be provided by fusion bonding or welding. For example, when the polymer layer is heated some melting occurs, and upon application of pressure and cooling, fusion bonding of the polymer layer to the structural member occurs.

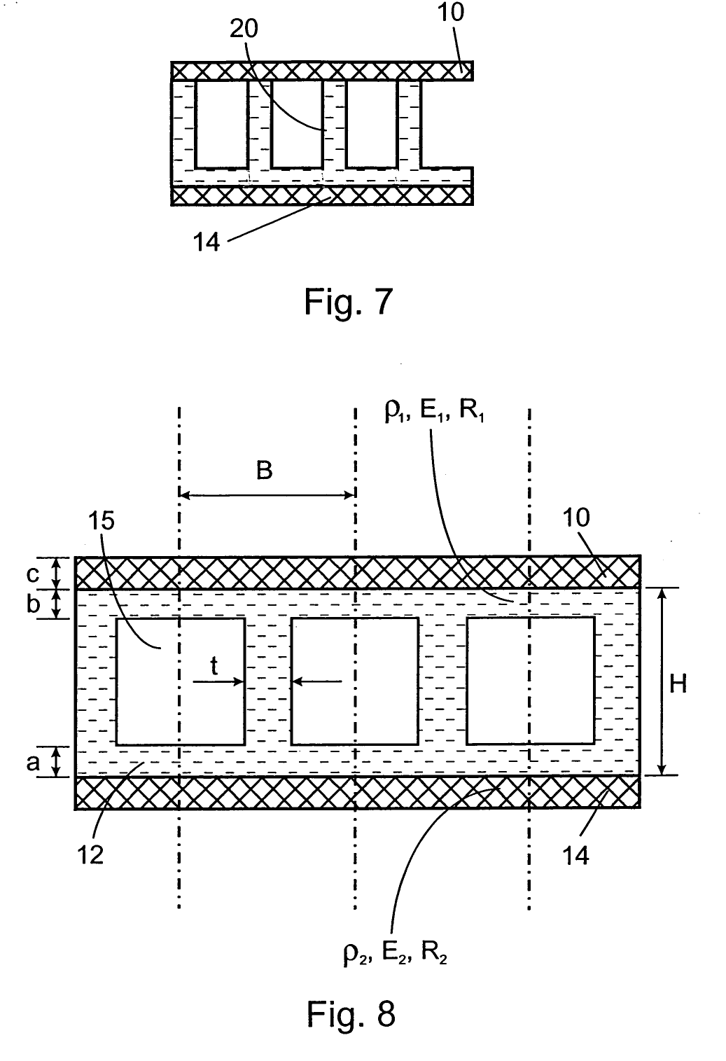

The layers of polymer (10 and 14) can be also reinforced with fillers, fibers and the like. The structural member 12 can comprise, at least partially the same polymer, or a material compatible or miscible with the material of the lower 14 and/or upper 10 layer material. The physical and/or chemical properties of the structural member 12 can be selected depending on the desired application, which can be flooring or any other applications contemplating high strength, high stiffness, high fatigue resistance, high creep resistance and/or high environment resistance applications. The structural member can be solid, such as shown on FIGS. 1, 2 or 3, or as having an internal hollow profile in the form of a series of channels of various cross-sectional shapes, such as square-channel (15 on FIG. 4), triangular-channel (16 on FIG. 5), circular-channel (18 on FIG. 6), L profile (20 on FIG. 7), or C profile (not shown).

The materials for the upper and/or lower layers comprise, at least partially, any polymeric material suitable for the particular application intended. Polymeric materials may be classified in a number of different ways. A suitable polymeric material may comprise a homopolymer, a copolymer, a terpolymer, or a mixture thereof. The polymeric material may comprise amorphous or crystalline polymers. The polymeric material may comprise hydrophobic or hydrophilic polymers. The polymeric material may comprise linear, branched, star, cross-linked or dendritic polymers or mixtures thereof. Polymer matrices can also be conveniently classified as thermoplastic, thermosetting and/or elastomeric polymers. The proposed polymers include principally polymeric material of the thermoplastic type, namely, olefinics (i.e. polyolefins), vinylics, styrenics, acrylonitrilics, acrylics, cellulosics, polyamides, thermoplastic polyesters, thermoplastic polycarbonates, polysulfones, polyimides, polyether/oxides, polyketones, fluoropolymers, copolymers thereof, or mixtures thereof.

Some suitable olefinics (i.e. polyolefins) include, for example, polyethylenes (e.g. LDPE, HDPE, LLDPE, UHMWPE, XLPE, copolymers of a ethylene with another monomer), polypropylene, polybutylene, polymethylpentene, or mixtures thereof. Some suitable vinylics include, for example, polyvinylchloride, chlorinated polyvinylchloride, vinyl chloride-based copolymers, polyvinylidenechloride, polyvinylacetate, polyvinylalcohol, polyvinyl aldehydics (e.g. polyvinylacetal), polyvinylalkylethers, polyvinylpyrrolidone, polyvinylcarbazole, polyvinylpyridine, or mixtures thereof. Some suitable styrenics include, for example, polystyrene, polyparamethylstyrene, polyalphamethylstyrene, high impact polystyrene, styrene-based copolymers, or mixtures thereof. Some suitable acrylonitrilics include, for example, polyacrylonitrile, polymethylacrylonitrile, acrylonitrle-based copolymers, or mixtures thereof. Some suitable acrylics include, for example, polyacrylicacid, polymethacrylicacid, polymethacrylate, polyethylacrylate, polybutylacrylate, polymethylmethacrylate, polyethylmethacrylate, cyanoacrylate resins, hydroxymethylmethacrylate, polacrylamide, or mixtures thereof. Some suitable cellulosics include, for example, cellulose, cellulose esters, celluloseacetates, mixed cellulosic organic esters, cellulose ethers, methylcellulose, ethylcellulose, carboxymethylcellulose, hydroxyethylcellulose, or mixtures thereof. Some suitable polyamides include, for example, aliphatic polyamides (e.g. nylons), aromatic polyamides, transparent polyamides, or mixtures thereof. Some suitable thermoplastic polyesters/polycarbonates are, for example, polyalkylene terephthalates (e.g. polyethylene terephthalate), polycyclohexanedimethanol terephthalates, polyarylesters (e.g. polyarylates), polycarbonate, or mixtures thereof. Some suitable polysulfones include, for example, diphenylsulfone, polybisphenolsulfone, polyethersulfone, polyphenylethersulfones, or mixtures thereof. Some suitable polyimides include, for example, polyamideimide, polyetherimide, or mixtures thereof. Some suitable polyether/oxides include, for example, polymethyleneoxides, polyethyleneoxide, polypropyleneoxide, polyphenyleneoxides, or mixtures thereof. Some suitable polyketones include, for example, polyetheretherketone-1. Some suitable fluropolymers include, for example, polytetrafluoroethylene, polychlorotrifluoroethylene, polyvinylfluoride, polyvinylidenefluoride, polyperfluoroalkoxy, polyhexafluoropropylene, polyhexafluoroisobutylene, fluoroplastic copolymers, or mixtures thereof.

Since the polymer layer is fused to the structural member, the following polymer materials are also contemplated. Thermosetting polymers (thermosetting resins) generally arise from a complex combination of polymerization and cross-linking, which converts low- or relatively low-molecular weight molecules into tight three-dimensional networks. The reaction is irreversible and the resulting polymeric species is generally very hard. The polymerization and cross-linking reactions may be temperature-activated, catalyst-activated or mixing-activated. Some suitable thermosetting polymers, include, for example, formaldehyde systems, furan systems, allyl systems, alkyd systems, unsaturated polyester systems, vinyester systems, epoxy systems, urethane/urea systems, or mixtures thereof.

Some suitable formaldehyde systems include, for example, urea-formaldehyde resins, melamine-formaldehyde resins, phenol-formaldehyde resins, or mixtures thereof. Some suitable furan systems include, for example, furan resins, furfural resins, furfuryl alcohol resins, or mixtures thereof. Some suitable allyl systems include, for example, diallylphthalate, diallylisophthalate, diethyleneglycolbisallylcarbonate, or mixtures thereof. Some suitable alkyd systems include, for example, the reaction of ethylene glycol glycerol and phthalic acid with fatty acids. Some suitable unsaturated polyester systems include, for example, one component which is a polyester product of a reaction between a difunctional acid or anhydride (e.g. maleic acid, maleic anhydride, phthalic anhydride, terephthalic acid) with a difunctional alcohol (e.g. ehtylene glycol, propylene glycol, glycerol), and, a second component which is a monomer capable of polymerizing and reacting with unsaturations in the polyester component (e.g. styrene, alphamethylstyrene, methylmethacrylate, diallylphthalate). Some suitable vinylester systems include, for example, the reaction of diglycidyl ether of bisphenol A with methacrylic acid. Some suitable epoxy systems include, for example, the reaction between epichlorohydrin and a multifunctional acid, amine or alcohol. Some suitable urethane/urea systems include, for example, the reaction product of a liquid isocyanate (e.g. 2,4-toluenediisocyanate, 2,6-toluenediisocyanate) and a polyol (e.g. polyethylene ether glycol, polypropylene ether glycol).

Elastomeric polymers (elastomers) can generally be defined as materials capable of large elastic deformations and are often referred to as rubbers. Elastomers may be classified as vulcanizable elastomers, reactive system elastomers and thermoplastic elastomers. Some suitable elastomers include, for example, polyisoprene, polybutadiene, polychloroprene, polyisobutylene, styrene-butadiene rubber, acrylonitrile-butadiene rubber, ethylene-propylene rubber, ethylene-propylene-diene rubber, chlorinated polyethylene, chlorosulfonated polyethylene, ethylene-vinylacetate copolymer, ethylene-acrylate copolymer, fluoroelastomers (e.g. polyvinylidene fluoride, polychlorotrifluoroethylene), silicone polymers (e.g. polydimethylsiloxane), acrylic rubber, epichlorohydrin rubber, polysulfide rubbers, propyleneoxide rubbers, polynorbomene, polyorganophosphazenes, olefininc thermoplastic rubbers, styrenic thermoplastic rubbers, urethane thermoplastic rubbers, etherester thermoplastic rubbers, etheramide thermoplastic rubbers, or mixtures thereof.

In addition to their polymeric nature, the materials used for the external overlay layer(s) and internal structural base member could be heterogeneous in nature, in the form of pre-impregnated or commingled fabrics. To obtain specific properties, characteristics, specific weight, cost, the materials used for the external layer(s) could be, for example, filled by fibers, fillers, particles, whiskers, flour, or any other type of discontinuous fillers. They could also be fiber-reinforced composites, either unidirectional, bidirectional, tridirectional, random, such a mat of fiber or random/oriented, with a multi-layered, or 2D or 3D fabric-type structures, or could be composed of mixtures thereof. They could also have an oriented structure such that their mechanical properties in 1, 2 or 3 directions are improved as a result of macromolecular orientation. They could also have a surface texture to improve their appearance or to resemble specific surface finish. They could also be cosmetic in function.

Similarly, the materials used for the internal structural base member could be, for example, composed of the same materials, mixtures and/or structures as those described for the external layer(s). In addition, they could have a foamed or porous internal structure as described above. They could also have specific profile geometry such as honeycomb structures.

FIG. 8 illustrates the geometry of a layered product comprising, as an example, square-channel hollow profiles 15, a structural member 12, an upper layer 10 and a lower layer 14 of polymer. Dimension “c” relates to the thickness of the upper layer 10 and of the lower layer 14 of polymer. Dimension “a” relates to the thickness of the lower flange of structural member 12. Dimension “b” relates to the thickness of the upper flange of the structural member 12. Dimension “t” relates to the thickness of the wall between two consecutive square-channel hollow profiles 15. Dimension “B” relates to the center-to-center periodic distance between square-channel hollow profiles 15 and dimension “H” to the thickness of the internal structural member 12. Density ρ₁, Young's modulus E₁ and flexural strength R₁ relate to the material of the structural member 12, while density ρᵢ, Young's modulus E₁ and flexural strength R₁ relate to the material of the upper 10 and lower layer 14.

In order to predict the performance, weight and cost of the present invention, some calculation can be made to adjust these criteria to the desired properties, and to validate the potential of the profile. Regarding performance, the improvements in strength can be predicted from simple calculations based on the beam theory for different geometries of the laminated composite material, such as shown in FIGS. 1-7, amongst other possible profiles.

The basic equations for the second moment of a multiple section profile with respect to the neutral axis are as follows:

I_{G}=ΣI_{Gi}+Σ(yᵢ−y)²Aᵢ (1)

$$\overline{y} = \frac{\sum {\overline{y}}_{i} {A}_{i}}{\sum {A}_{i}} \qquad ( 2 )$$

where I_{Gi} is the global second moment of section, I_{Gi} is the second moment of sub-section i, yᵢ is the distance of sub-section i to the neutral axis, y is the position of the neutral axis and Aᵢ is the surface of sub-section i. The maximum stress ca at the up most or lowest fiber is given by:

$$σ = \frac{M}{{I}_{G} / c} \qquad ( 3 )$$

where M is the bending moment and I_{G}/c is the section modulus, given by the ratio of the global second moment of section to the distance between the up most or lowest fiber and the neutral axis. The ratio of maximum stress

$$\frac{{σ}_{1}}{{σ}_{2}}$$

calculated from Eq. 3 for two geometries 1 and 2 for a given bending moment is thus given by:

$$\frac{{σ}_{1}}{{σ}_{2}} = \frac{{( {I}_{G} / c )}_{2}}{{( {I}_{G} / c )}_{1}} \qquad ( 4 )$$

Thus, a

$$\frac{{σ}_{1}}{{σ}_{2}}$$

ratio above 1 indicates that the maximum stress developed in profile 2 is lower than the maximum stress developed in profile 1, i.e. the profile 2 has improved strength compared to profile 1, which is generally chosen for its known properties, usually close to the desired properties for a specific application.

Different geometries of laminated composite material are compared. The materials considered in the latter are described in Table 1. The comparison of different geometries of laminated composite material based on their section moduli is given in Table 2. The geometries considered in Table 2 refer to the schematic profile in FIG. 7. Also provided in Table 2 are the respective weights W and cost C per unit surface of each geometry considered. These values are considered as references, since they are subjected to fluctuations (economic, environmental, etc.), and should be seen as fairly conservative. Table 3 provides a summary of these calculations.

TABLE 1
Properties of the different materials considered in the different
geometries of laminated composite material.

| | Density | Modulus | Strength | Cost |
|---|---|---|---|---|
| Material | (kg/m³) | (GPa) | (MPa) | ($/kg) |
| solid wood (maple) | 740 | 9.6 | 90 | 1.10 |
| wood fiber (pine) polypropylene | 1040 | 4.1 | 58 | 0.80 |
| composite | | | | |
| continuous glass fiber | 1540 | 12.0 | 300 | 4.90 |
| polypropylene composite | | | | |

TABLE 2
Comparison of section moduli of laminated composite material
based different geometries (refer to FIG. 7 for dimensions).

| | | | | a = b | c | l/c | W | C |
|---|---|---|---|---|---|---|---|---|
| Profile Geometry | H (mm) | B (mm) | t (mm) | (mm) | (mm) | (mm³) | (kg/m²) | ($/pi²) |
| 100% solid wood | 31.8 | 40.0 | 40.0 | n/a | n/a | 6741.6 | 23.3 | 25.6 |
| core of solid wood | 27.8 | 40.0 | 40.0 | n/a | 2.0 | 7301.0 | 26.5 | 52.4 |
| skin of continuous | | | | | | | | |
| fiber composite | | | | | | | | |
| core of wood fiber | 27.8 | 40.0 | 6.0 | 4.0 | 2.0 | 9734.0 | 17.4 | 39.5 |
| composite with | | | | | | | | |
| square channels | | | | | | | | |
| skin of continuous | | | | | | | | |
| fiber composite | | | | | | | | |

TABLE 3
Summary of the strength(d*), weightW*) and cost(C*)
calculations for the laminated composite material with respect to solid wood.

| Profile Geometry | ${σ}^{*} = \frac{{σ}_{wood}}{{σ}_{profile}}$ | ${W}^{*} = \frac{{W}_{profile}}{{W}_{wood}}$ | ${C}^{*} = \frac{{C}_{profile}}{{C}_{wood}}$ | $\begin{matrix}Balance = \\ \frac{{σ}^{*}}{{W}^{*} \cdot {C}^{*}}\end{matrix}$ |
|---|---|---|---|---|
| core of solid wood | 1.08 | 1.14 | 2.05 | 0.46 |
| 2 skins of continuous | | | | |
| fiber composite | | | | |
| core of wood fiber | 1.44 | 0.75 | 1.54 | 1.25 |
| composite with | | | | |
| square channels | | | | |
| 2 skins of continuous | | | | |
| fiber composite | | | | |

The results in Table 3 show that simply adding an upper and lower continuous fiber composite skin of 2 mm in thickness unto a core of conventional solid wood (FIG. 3) leads to improvements in profile strength of 8% with respect to solid wood only at equal thickness. When considering two skins of continuous fiber composite of 2 mm in thickness and a wood fiber composite core with square channels (FIG. 4), the profile strength is improved by 44% with respect to solid wood only.

The second criterion is weight. The calculations in Table 3 show that the weight per unit surface W* of the profile consisting of an upper and lower continuous fiber composite skin of 2 mm in thickness on a core of conventional solid wood (FIG. 3) is 14% higher than that of wood. However, the weight per unit surface W* of the profile consisting of two skins of continuous fiber composite of 2 mm in thickness and a wood fiber composite core with square channels (FIG. 4) is 25% lower than that of wood, as shown in Table 3.

The third criterion is cost. Based on real costs of wood and laminated composite materials obtained from the industry (Table 1), the cost per unit surface C* of the different profile geometries considered in Table 2 and FIG. 7 is estimated in Table 2. The calculations in Table 3 show that the cost per unit surface C* of the profile consisting of an upper and lower continuous fiber composite skin of 2 mm in thickness unto a core of conventional solid wood (FIG. 3) is 105% higher than that of wood. As shown in Table 3, however, the cost per unit surface C* of the profile consisting of two skins of continuous fiber composite of 2 mm in thickness and a wood fiber composite core with square channels (FIG. 4) is 54% higher than that of wood.

The balance between profile strength, weight and cost for each profile considered is also provided in Table 3. This balance reflects the profile strength at given weight and cost with respect to solid wood. The balance calculated indicates that the profile consisting of an upper and lower continuous fiber composite skin of 2 mm in thickness on a core of conventional solid wood (FIG. 3) is 54% weaker for a given weight and cost. As shown in Table 3, however, the balance calculated for the profile consisting of two skins of continuous fiber composite of 2 mm in thickness and a wood fiber composite core with square channels (FIG. 4) is 25% stronger than solid wood for a given weight and cost.

In addition to the previous theoretical calculations, experimental trials have also been completed from prototypes obtained from Stampint and testing them in three-point bending. The geometry of each type of prototype is described in Table 4. Also in Table 4 are the stress and strain at break results obtained. These results indicate that the stress and strain at break of a profile consisting of an upper and lower continuous fiber composite skin of 2 mm in thickness on a core of polypropylene are significantly above those of solid wood. They also show that using a commercially available wood fiber composite in a similar profile structure, i.e. one consisting of an upper and lower continuous fiber composite skin of 2 mm in thickness on a core of wood fiber composite, also results to property improvements with respect of solid wood and leads to even higher stress at break.

TABLE 4
Prototype geometry description and performance.

| | | | Stress at | Strain at |
|---|---|---|---|---|
| | Thickness | | break | break |
| Prototype | (mm) | | (MPa) | (%) |
| core of polypropylene | core = | 25.4 | 119 | 6.0 |
| 2 skins of continuous | upper skin = | 2.0 | | |
| fiber composite | lower skin = | 2.0 | | |
| | total = | 29.4 | | |
| core of wood fiber | core = | 25.4 | 131 | 4.5 |
| composite | upper skin = | 2.0 | | |
| 2 skins of continuous | lower skin = | 2.0 | | |
| fiber composite | total = | 29.4 | | |
| solid wood | total = | 31.8 | 90 | 2.7 |

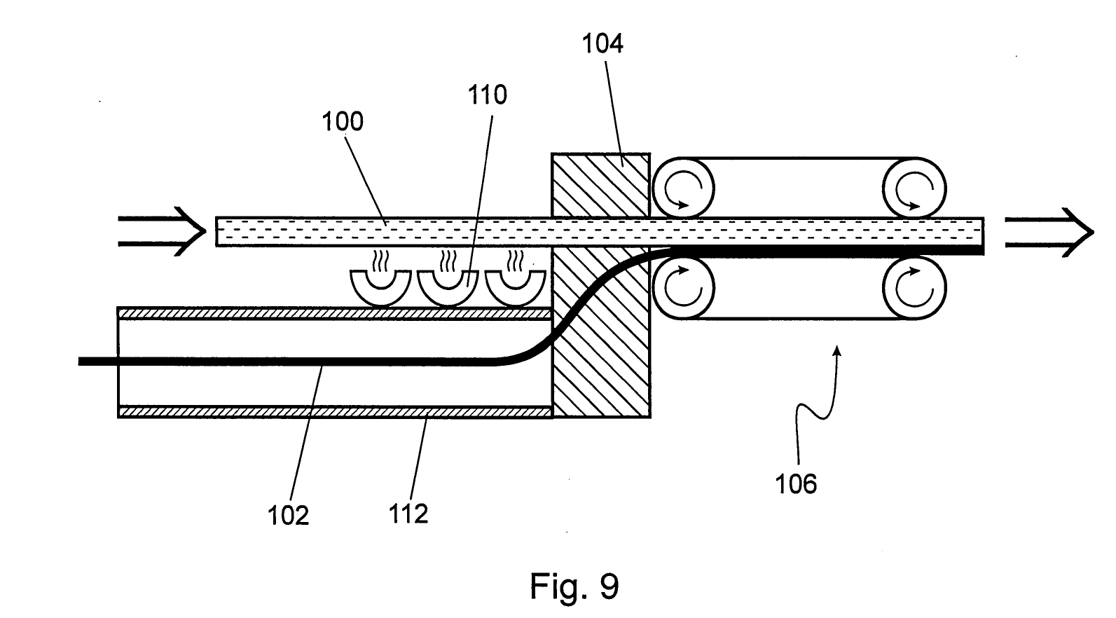

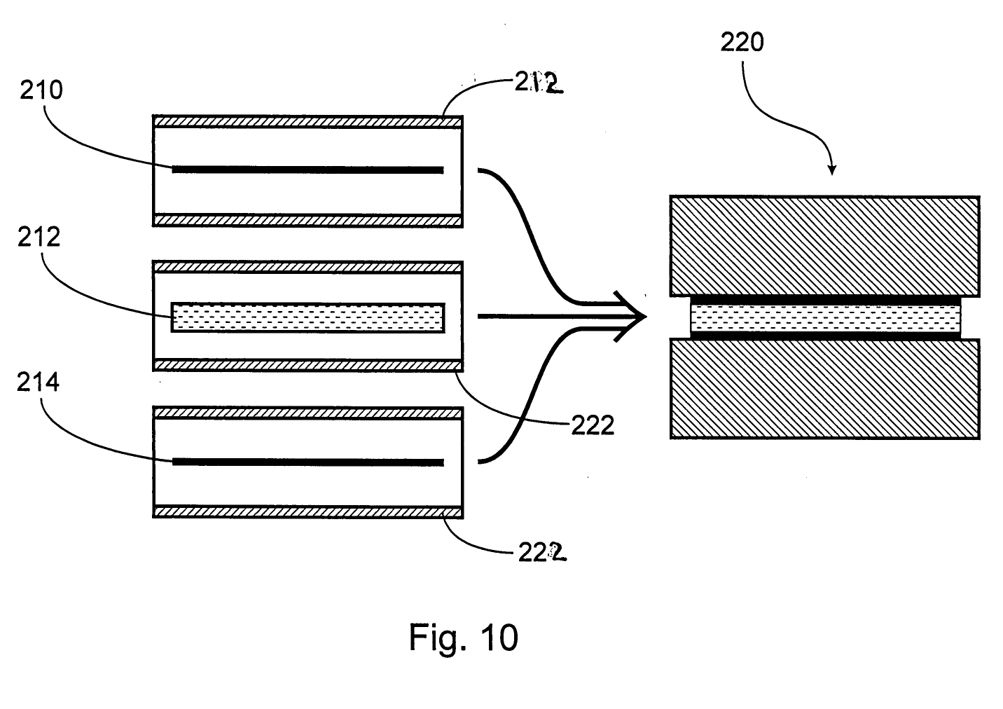

As seen in FIG. 9, a continuous process is provided to produce laminated polymer composite materials, according to the present invention. A polymer material in the form of a structural member 100 is extruded, pultruded or cold drawn. The polymer structure comprises preferably polypropylene (PP) including 30-60 wt. % of high aspect ratio wood fibers. As mentioned above, the polymer structure could have an internal hollow profile structure to minimize weight and costs. Referring to FIG. 9, a fiber-reinforced PP fabric strip 102 is applied continuously to the polymer structure. In this example, on only one major surface of the polymer structure 100. Heating means 110 provided in an oven 104 is directed at the major surface of the polymer structure 100 to be heated. At the exit of oven 104, the fiber-reinforced PP fabric 102 is continuously put in contact with the bottom and/or top major surface of the polymer structure using a calender press 106 or any combination of mechanical guides and rollers applying pressure on continually moving strips of materials. If necessary, the fiber-reinforced PP fabric 102 could be pre-heated into a heated tunnel 112 prior to the lamination step. Due to the high thermal mass of the polymer structure, the surface of the fiber-reinforced PP fabric in contact with the structure would partly melt and adhere to it. If more than one layer of fiber-reinforced PP fabric is to be applied, each layer would have to be heated, using heating means 110 directed to their surface to be heated and/or using a heated tunnel 112. This additional heating step insures that the fiber-reinforced PP fabric adheres well to the extruded or pultruded polymer structure. The structure and its upper and lower fiber-reinforced PP fabric layers would then enter a heating/cooling calender press 106. The pressure, temperature and rolling speed of the calender press 106 would be such that optimal consolidation of the continuous fiber-reinforced PP fabric is obtained. By using pressure and heat on a fiber-reinforced polymer on either or both major surfaces of a structural member containing sufficient amount of the same polymer, or one that is compatible or miscible, leads to very large improvements in performance.

Depending on the size and/or volume of material to produce, it is also possible to use a batch process. Referring to FIG. 10, at least one major surface of a base polymer sheet 212 is preheated using preferably non-contact heating means 222, such as, for example, an IR oven. It is also possible, depending on the material and/or conditions, to preheat fiber reinforced polymer overlay sheet(s) (210 and 214) using preferably non-contact heating means, such as, for example, heating oven or heated tunnel. When the temperature of the upper 210 and/or lower 214 fiber-reinforced polymer overlay sheets and base polymer sheet 212 is sufficiently high, the individual lengths of an upper 210 and/or lower layer 214 fiber-reinforced polymer overlay sheets are be placed onto and below the base polymer sheet 212, and then consolidated in a roll-forming, compression molding or thermoforming system 220.

It is understood that the present invention is not limited to the sole embodiments described above, but encompasses any and all embodiments within the scope of the following claims.

What is claimed is:

1. A laminated polymer composite material comprising, a base structural member having at least one major surface and an overlay layer of polymer linked to at least a portion of said at least one major surface of the structural member, wherein the polymer is any polymer which can be thermally activated to obtain chemical and/or physical links with the structural member.

2. The laminated material of claim 1, wherein the structural member is of a material compatible or miscible with the material of the polymer layer.

3. The laminated material of claim 2, wherein the structural member is at least partially made of the same material as the polymer layer.

4. The laminated material of claim 3, wherein the polymer is a thermoplastic polymer.

5. The laminated material of claim 1, wherein a layer of polymer is fusion bonded to one major surface of the structural member.

6. The laminated material of claim 5, wherein an additional layer of polymer is fusion bonded to another major surface of the structural member, located on the opposite side of the structural member.

7. The laminated material of claim 1, wherein the structural member is a solid body.

8. The laminated material of claim 6, wherein the structural member has an internal hollow profile.

9. The laminated material of claim 8, wherein the thermoplastic polymer is reinforced with a filler or fibres.

10. The laminated material of claim 9, wherein the polymer is reinforced with wood fibres.

11. The laminated material of claim 10, wherein the structural member is made of a fibre-reinforced thermoplastic polymer.

12. The laminated material of claim 11, wherein the polymer overlay is in the form of a fibre-reinforced fabric.

13. The laminated material of claim 12, wherein the hollow structural profile of the structural member is in the form of a series of channels of a cross-sectional shape selected from the group consisting of square, triangular, circular and L-shaped.

14. The laminated material of claim 13, wherein the base structural member material is polypropylene reinforced with 30-60%/w of wood fibres, and wherein the polymer overlay layer material is fibre reinforced polypropylene fabric.

15. A process to produce a laminated polymer composite material as defined in claim 1, comprising the steps of:
(a) heating at least a portion of at least one major surface of a base structural member,
(b) bringing at least one overlay layer of polymer material into contact with said at least one major surface of the structural member, and
(c) applying pressure to link the base structural member to the polymer layer.

16. The process of claim 15, wherein the process is a continuous process and the structural member and the polymer layers are in the form of strips of materials.

17. The process of claim 15, wherein the process is a batch process and the structural member and the polymer layers are in the form of sheets of materials.

18. An apparatus to produce a laminated polymer composite material as defined in claim 1 comprising:
heating means for heating at least a portion of at least one major surface of a structural base member, means for bringing a layer of polymer into contact with said at least one major surface of the structural member, and press means for applying pressure to link the structural member to the layer of polymer material.

19. The apparatus of claim 18, wherein the press means comprises a combination of mechanical guides and rollers applying pressure by sandwiching the layer of polymer and the internal structural member.

20. The apparatus of claim 18, wherein the press means is a roll-forming, compression molding or thermoforming system.
